(19) United States
(12) Patent Application Publication
(10) Pub. No.: US 2021/0045287 A1
(43) Pub. Date: Feb. 18, 2021

(54) MARKED TRIMMER LINE AND ASSOCIATED ASSEMBLIES AND METHODS

(71) Applicant: Shakespeare Company, LLC, Greer, SC (US)

(72) Inventors: John Dean Yarborough, Columbia, SC (US); James Richard Payne, Chapin, SC (US); David Benson Skinner, Columbia, SC (US); Brian Keith Searfoss, Elgin, SC (US); Jonathan David O'Neal, Irmo, SC (US); Kelly Ross Ackley, Lexington, SC (US)

(21) Appl. No.: 17/051,263

(22) PCT Filed: Apr. 30, 2019
(86) PCT No.: PCT/US2019/029932

§ 371 Date: Oct. 28, 2020

Related U.S. Application Data
(60) Provisional application No. 62/664,838, filed on Apr. 30, 2018.
(60) Provisional application No. 62/686,215, filed on Jun. 18, 2018.

(51) Int. Cl. A01D 34/416; B65D 83/02; B65D 75/22; B65D 85/04; B65H 49/20; B65H 75/32

(52) U.S. Cl. CPC A01D 34/416; B65D 83/02; B65H 75/32; B65D 85/04; B65H 49/205; B65D 75/22

(57) ABSTRACT

Trimmer lines having length indicators disposed along the external surface of its elongated body, packages containing the same, and methods of manufacturing such trimmer line are provided. The trimmer lines have length indicators disposed along the external surface at regular increments of at least about 6 inches to indicate a measured length of the trimmer line of at least 6 inches.

### CROSS-REFERENCE TO RELATED APPLICATIONS

This application claims priority benefit of U.S. Provisional Applications No. 62/664,838, filed Apr. 30, 2018, and 62/686,215, filed Jun. 18, 2018, the disclosures of which are incorporated by reference herein in their entirety.

### BACKGROUND

The present application relates generally to trimmer lines and relates more particularly to trimmer lines with markings designating one or more lengths along the trimmer line.

String trimmer line, also referred to as trimmer line or monofilament, is designed for use in string trimmer heads and may come in various sizes and cross-sectional shapes depending on the particular string trimmer machine and desired application. Typically, string trimmer machines are used to cut or trim grass and weeds. The machines are often used to edge around trees, near fences, and along driveways, sidewalks, and walls, as well as along landscape borders. Conventional string trimmer machines include an elongated shaft with a power driven rotating element or gearhead near the end of the elongated shaft and a trimmer head attached to the rotating element or gearhead. Typically, the trimmer head is configured to receive and retain one or more trimmer lines therein such that the trimmer head rotates the trimmer line(s) at high speed, allowing the trimmer line to cut and trim vegetation as described above. Trimmer line having improved functionality for increasing efficiency of use would be desirable.

### SUMMARY

In one aspect, trimmer line is provided, including an elongated body having an external surface and a plurality of length indicators disposed along the external surface of the elongated body. The length indicators are disposed along the external surface at regular increments of at least about 6 inches to indicate a measured length of the trimmer line of at least 6 inches.

In another aspect, trimmer line package assemblies are provided, including a package having a first side and a second side, wherein the first side is coupled to the second side to form an at least partially enclosed volume, the package further comprising at least one aperture for dispensing trimmer line from the at least partially enclosed volume, and a trimmer line such as described above disposed within the at least partially enclosed volume.

In yet another aspect, methods of manufacturing trimmer line are provided, including providing an elongated trimmer line body comprising an external surface, and disposing a plurality of length indicators along the external surface of the elongated body at regular increments of at least about 6 inches to indicate a measured length of the trimmer line of at least 6 inches.

### BRIEF DESCRIPTION OF THE DRAWINGS

Referring now to the drawings, which are meant to be exemplary and not limiting, and wherein like elements are numbered alike. The detailed description is set forth with reference to the accompanying drawings illustrating examples of the disclosure, in which use of the same reference numerals indicates similar or identical items. Certain embodiments of the present disclosure may include elements, components, and/or configurations other than those illustrated in the drawings, and some of the elements, components, and/or configurations illustrated in the drawings may not be present in certain embodiments.

FIG. 1 is a perspective view of one embodiment of a marked trimmer line in accordance with the disclosure.

FIG. 2 is a perspective view of another embodiment of a marked trimmer line in accordance with the disclosure.

FIG. 3 is a perspective view of another embodiment of a marked trimmer line in accordance with the disclosure.

FIG. 4 is a perspective view of another embodiment of a marked trimmer line in accordance with the disclosure.

FIG. 5 is a perspective view of an embodiment of a trimmer line package assembly in accordance with the disclosure.

FIG. 6 is a perspective view of another embodiment of a trimmer line package assembly in accordance with the disclosure.

### DETAILED DESCRIPTION

The present disclosure provides for trimmer lines that have spaced indicators for one or more measured lengths along the trimmer line, along with assemblies that include the trimmer line and methods for manufacturing such trimmer line. For example, the trimmer line may be packaged in an assembly with a cutting element configured to allow one to precisely remove a specific length of trimmer line from within the package without the need for further measuring tools. The trimmer line may be produced by a process configured to create markings during the production of the trimmer line, or the markings may subsequently be associated with the line through suitable methods.

Trimmer line may be packaged on a spool or in another wound configuration (e.g., wound without a spool) and can be stored in a variety of packages. For example, the package may be used to deliver the trimmer line in an organized and untangled manner to the end user. For example, a user may load the trimmer line into a trimmer head by unspooling or unwinding the trimmer line, cutting a piece of the trimmer line off the spool, and loading the line into the trimmer head. For example, a cutting element may be associated with the package to provide easy dispensing and cutting of the line. In some embodiments, an entire spool or coil of trimmer line is loaded into the trimmer head. Advantageously, the presently described trimmer line provides a user with visual or tactile indications of length, to allow for consistent and efficient trimming of the line into desired line segments.

The trimmer lines described herein are suitable for a variety of different trimmers and trimmer heads. For example, the trimmer line may be capable of loading into an auto feed trimmer head, a bump feed trimmer head, a cartridge trimmer head, a fixed line trimmer head, or a brush cutter trimmer head. One benefit to the trimmer line length indicators disclosed herein is the trimmer line may be cut precisely by a user to fit one or more trimmer heads. For example, one type of trimmer head, the bump feed trimmer head, some models may hold ten feet of trimmer line and a second model may have the capacity to hold sixteen feet of trimmer line. Bump feed trimmer heads typically have two eyelets located on opposite sides of the head. The lengths of trimmer line extend through the eyelets and outward for trimming grass and weeds. A middle portion of the trimming line is wound on a spool located within the trimmer head. Loading the trimmer line beyond the maximum capacity can cause the trimmer line to become jammed or wedged against the internal walls of the trimmer head (e.g., loading sixteen feet of trimmer line into a head design to only hold ten feet of trimmer line). Thus, the length indicators described herein may help a user to accurately load a particular trimmer line length (e.g., 10 feet, 16 feet, 20 feet) within a trimmer head, thus preventing jams. Moreover, the length indicators may provide a user the ability to efficiently dispense or measure a length of line (e.g., from 10 to 20 feet) simply by counting the appropriate number of length indicators along the body of the line being dispensed. That is, a user may count 5 or 10 indicators as the line is being dispensed from a package to obtain a desired line length of 10 or 20 feet, without the need for further measuring tools.

The trimmer line and assemblies thereof that are described herein may be configured for use with a variety of trimmers and trimmer heads, including but not limited to those described in U.S. Patent Application Publication No. 2016/0324067 to Skinner et al., U.S. Patent Application Publication No. 2017/0172063 to Skinner et al., U.S. Patent Application Publication No. 2018/0177122 to Skinner, U.S. Pat. No. 9,801,335 to Skinner, U.S. Pat. No. 9,861,033 to Skinner et al., U.S. Pat. No. 9,861,034 to Skinner, U.S. Pat. No. 9,986,682 to Skinner et al., U.S. Pat. No. 10,136,577 to Skinner, and U.S. Pat. No. 10,178,827 to Skinner, the disclosures of which are incorporated by reference herein in their entirety.

As used herein, “trimmer line” and “monofilament” are interchangeable terms to refer to a thread or fiber-like structure composed from a thermoplastic material. For example, the filament or line may be made in an extrusion process as are known in the art.

### Trimmer Line and Trimmer Line Length Indicators

In one aspect, a trimmer line is provided. The trimmer line has an elongated body with an external surface and a plurality of length indicators disposed along the external surface. In some embodiments, as shown in FIG. 1, the trimmer line 100 has a plurality of length indicators 102 disposed along the external surface of the elongated body. As used herein, the phrase “length indicator” is used to refer to any marking that provides visual or tactile identification (or both a visual and tactile indication) of a specific position along the length of the trimmer line. For example, one or more sets of length indicators may be used along a trimmer line to provide identification of certain lengths of trimmer line the length between two length indicators or the length between two pairs of length indicators), to allow a user to precisely and efficiently measure a desired length of the line, without the use of additional tools, such as rulers, measuring tapes, and the like.

For example, the plurality of length indicators 102 may be equally spaced (lengthwise) along the elongated body of the trimmer line 100. For example, the plurality of length indicators 102 may be continuous or discontinuous about the perimeter or circumference of the external surface of the body. As used herein, the terms “circumference” and “perimeter” are interchangeable and refer generally to a continuous line forming the boundary of a closed geometric figure, such as the cross-sectional shape of the trimmer line. For example, along the length of a trimmer line, a series of the length indicators may be disposed at approximately similar radial positions, such that a user viewing the line from a particular perspective will observe the series of indicators when the line is at rest (i.e., the line is not being twisted or otherwise manipulated). In some embodiments, the indicator is discontinuous about a given circumference or perimeter, such that the visual appearance is such that multiple (e.g., two, four, or more) radial positions of the line are marked.

As shown in FIG. 1 (not to scale), the plurality of length indicators 102 may be located at regular intervals along the continuous trimmer line body. In certain embodiments, the length indicators are disposed along the external surface of the elongated body at regular increments of at least about 6 inches to indicate a measured length of the trimmer line of at least 6 inches. For example, the plurality of length indicators 102 may be located at every 6 inches, every 9 inches, every foot (i.e., every 12 inches), every meter, or every yard along the continuous trimmer line 100. In certain embodiments, the plurality of length indicators 102 are located at increments of one foot. In sonic embodiments, the plurality of length indicators 102 may be located at increments of less than a foot, such as every 6 or 9 inches along the trimmer line 100. In other embodiments, the plurality of length indicators 102 may be located at increments of more than a foot along the trimmer line 100, such as at every 1.5 feet, 2 feet, 3 feet, 4 feet, 5 feet, 10 feet, or any lengths or ranges therebetween. As used herein, the terms “increment” and “interval” are interchangeable terms referring to a specific, predetermined length of trimmer line.

The plurality of length indicators 102 may include any marking or indicator that is distinguishable by a user as being distinct from the remainder of the elongated body of the trimmer line. For example, the plurality of length indicators 102 may be imprinted, sprayed, painted, printed, embedded, cut, embossed, stamped, engraved, carved, impressed, marked, or otherwise formed on the external surface of the body. In some embodiments, the plurality of length indicators 102 may be a physical marking such as a cut, indention, notch, raised protrusion, bump, rib, or other tactile marking.

In certain embodiments, the length indicators are disposed along the external surface of the elongated body such that the external surface of the elongated body comprises a substantially smooth, continuous surface. For example, in such embodiments, the length indicators may be painted, coated, or printed on the external surface of the elongated body in a manner so as to not substantially impact the surface topography of the line. That is, the length indicators may be formed on the external surface of the line body in a manner that avoids the appearance of any projection, protrusion, dimple, or other topographical surface imperfection to the naked eye. In some embodiments, the elongated body has a substantially constant cross-sectional shape (e.g., its cross-section surface is substantially constant) and/or cross-sectional area, along the length of the elongated body.

In some embodiments, the elongated body displays a substantially constant failure mode along the length of the elongated body. That is, in such embodiments, the length indicators, even if physical modifications of the surface such as notches, do not reduce the wear properties of the line or otherwise form a breakage point along the line.

The plurality of length indicators 102 may be any suitable shape. For example, the plurality of length indicators 102 may each be in the shape of an “X” or cross, a dot, or another shape configured to mark an exact location on the trimmer line 100. In some embodiments, each length indicator 102 includes a group or series of such markings. For example, each length indicator may include a series of dots or lines extending about the perimeter of the line. For example, each length indicator may include a cluster or other grouping of dots or markings. In some embodiments, the plurality of length indicators 102 include different colors, such as red, blue, orange, or green. For example, the plurality of length indicators 102 may be a different color than the elongated body of the trimmer line 100.

In some embodiments, as shown in FIG. 3, the plurality of length indicators 102 are provided in pairs along the trimmer line 100. For example, a pair may include two length indicators 102 that are positioned relatively close to one another (e.g., from about ⅛ inch to about 2 inches apart). For example, the pair may include two parallel length indicators. Each pair may provide an indication of a position at which to cut the line (e.g., between the two indicators 102). In such embodiments, the distance between each pair may be the distances described herein with respect to embodiments having individual length indicators spaced from one another (e.g., the distance between each adjacent pair may be one foot).

In some embodiments, as shown in FIG. 4, the plurality of length indicators 102 includes lines of different weights or appearances (e.g., thickness, boldness, or color) along the trimmer line 100. These distinct sets within the plurality of length indicators 102 may designate different lengths along the trimmer line 100. For example, a first length indicator 102A may be a thickness greater than a second length indicator 102B. The first length indicator 102A may designate each foot along the trimmer line 100. For example, from one first length indicator 102A to the next first length indicator 102A may measure one foot. The second length indicator 102B may measure a foot between each second length indicator 102B. In some embodiments, a foot may separate the first length indicator 102A from the second length indicator 102B. In other embodiments, different lengths may separate the plurality of length indicators 102. One benefit to various length indicators along the trimmer line is to allow varying length measurements along the same trimmer line 100. For example, the second length indicator 102B may be placed every foot along the trimmer line 100 and the first length indicators 102A may be placed every two feet along the trimmer line 100.

The trimmer line 100 may be of any suitable size, cross-sectional shape, and length. For example, the trimmer line 100 may have a diameter ranging from about 0000 American Wire Gauge (AWG) to about 40 AWG. As used herein, the term “about” refers to a margin of deviation of +/−2 percent of the amount of the numerical value being modified. In some embodiments, as shown in FIG. 1 (not to scale), the trimmer line 100 has a diameter 104 of from about 0.09 inches to about 0.1 inches. In other embodiments, the trimmer line 100 may have a different diameter. For example, the trimmer line 100 may have a diameter of about 0.040 inches, about 0.050 inches, about 0.065 inches, about 0.080 inches, about 0.095 inches, about 0.105 inches, about 0.130 inches, about 0.155 inches, about 0.175 inches, or any ranges therebetween.

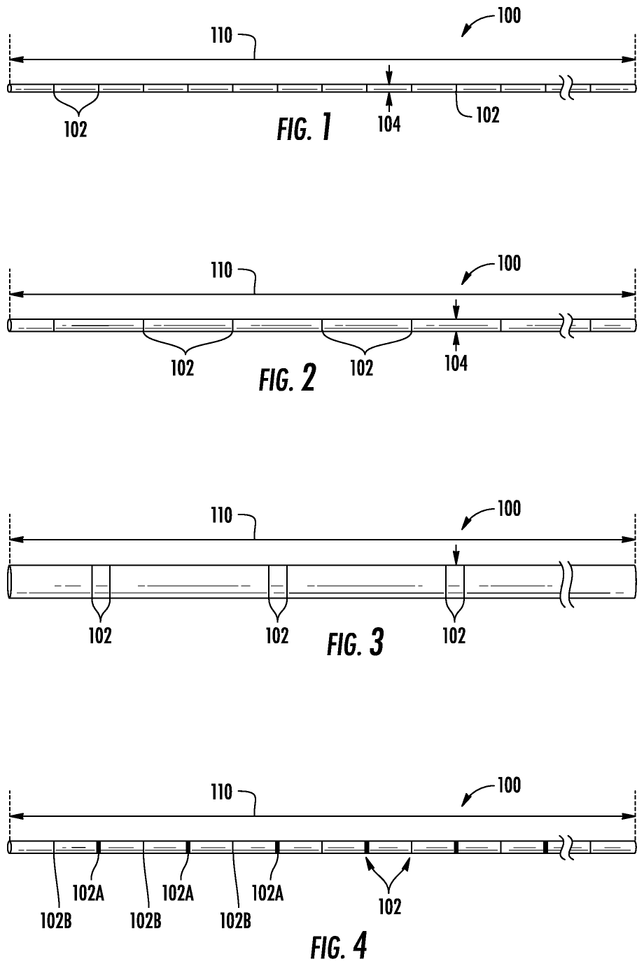

In some embodiments, as in FIGS. 1-4, the trimmer line 100 has a substantially circular cross-sectional shape. In other instances, the trimmer line 100 has another cross-sectional shape. For example, the trimmer line 100 may have a substantially triangular, substantially rectangular (e.g., square), or other suitable cross-sectional shape. The length 110 of the trimmer line 100 may vary. For example, as discussed below, trimmer line 100 may be packaged in lengths of up to about 5,000 feet of trimmer line 100 spooled within a package, such as in length of from about 10 feet to about 5,000 feet.

In some embodiments, the trimmer line 100 is rotated, or twisted, about its longitudinal axis. The rotation of the trimmer line 100 may be uniform throughout the line, such that the cross-sectional area of the line is consistent along its length. The degree of rotation may range from one twist per meter to 150 twists per meter. As used herein, a “twist” refers to a reference point on the circumference or perimeter of the trimmer line 100 cross-sectional shape rotating 360 degrees from a starting position about the longitudinal axis of the trimmer line 100. For example, U.S. Patent Application Publication No. 2016/0007528 to Skinner, which is incorporated by reference herein, discloses a trimmer line that is rotated about its longitudinal axis.

The trimmer line 100 may be formed of any suitable materials, or combinations of materials, such as thermoplastics. In some embodiments, the trimmer line 100 is composed of nylon. In other embodiments, the trimmer line 100 may be made of other types of plastics. For example, the trimmer line 100 plastic may be formed of polycarbonate, acetal copolymer polyoxymethlene, acetal homopolymer polyoxyrnethylene, polyethylene, polypropylene, polystyrene, polyvinyl chloride polyolefin, polyethylene teraphthalate, copolymers of polypropylene, copolymers of polyethylene, ethylene vinyl alcohol (EVOH), styrene, acrylonitrile butadiene styrene (ABS), polyvinyl chloride (PVC), polyvinylidene chloride (PVDC), copolymers of styrene, multilayer materials, composite materials, bioderived materials, biodegradable materials or any combination thereof. Such materials may be extruded or otherwise processed into the desired trimmer line form.

One benefit of the presently disclosed length indicators 102 is that a user can precisely cut along the marking to consistently cut similar lengths of trimmer line 100. As described herein, the trimmer line 100 may be housed in a package associated with a cutting element configured to split line easily and effectively into consistent lengths.

### Trimmer Line Packages and Cutting Elements

In some embodiments, the trimmer line 100 is stored in is a box or other package to form a trimmer line package assembly.

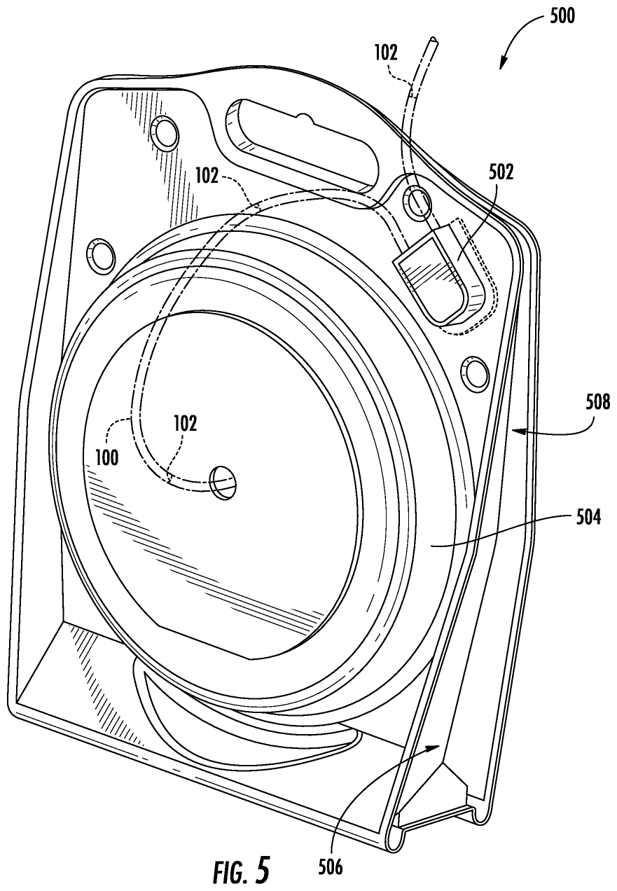

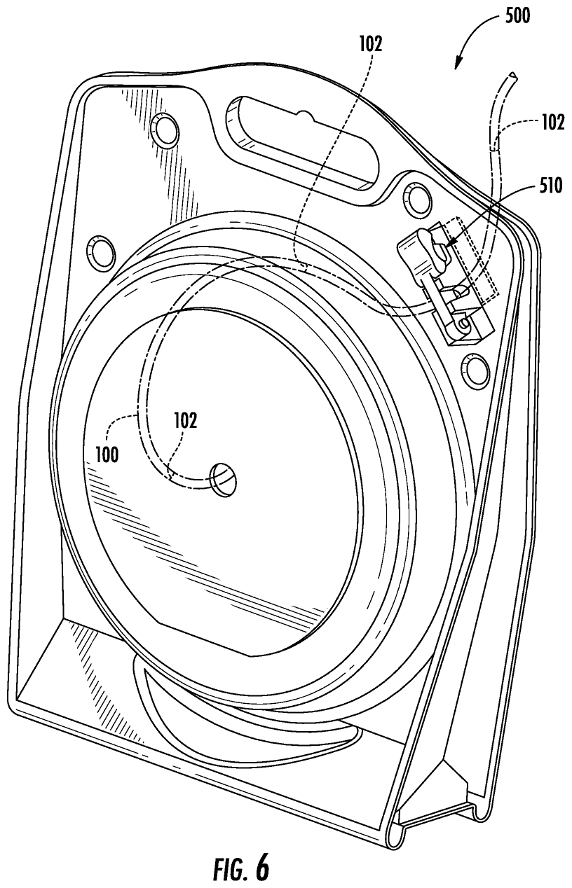

In some embodiments, as shown in FIGS. 5 and 6, a trimmer line package assembly 500 includes a package 504 having a first side 506 and a second side 508. The first side 504 is coupled to the second side 506 to form a partially enclosed volume, which is configured to house or at least partially contain trimmer line 100. The trimmer line may be any embodiment of trimmer line disclosed herein and may have any features or combinations of features disclosed herein. The package 508 includes at least one aperture or opening for dispensing the trimmer line 100 from the at least partially enclosed volume. In certain embodiments, the package for containing the trimmer line 100 may be a suitable clamshell type package.

In some embodiments, the trimmer line 100 is loosely wound within the enclosed volume. In other embodiments, the trimmer line may be wound about a spool. For example, the spool may be a cylindrical (or another suitable shaped) device about which the trimmer line is be wound. For example, the trimmer line 100 may be flexible enough to wrap around the spool and similarly unwrap from the spool when desired by a user. In some embodiments, the spool within the package may rotate about an axis. For example, as the spool is rotated about the axis, the trimmer line 100 may be withdrawn from within the package.

In some embodiments, the trimmer line 100 may be disposed within a package 504 that contains a cutting tool 502/510 (also referred to as a “cutting element” or “cutting device”, interchangeably, herein), as shown in FIGS. 5 and 6. Any suitable cutting elements may be used, to provide a user with the ability to measure a desired length of trimmer line based on the length indicators on the elongated body and to cut the desired length of line without additional tools or devices other than the package assembly 500.

The cutting element may include a serrated edge coupled to the package at which the trimmer line 100 may be pulled across to be severed. In other embodiments, the cutting element may include scissors or another type of blade (e.g., razor blade). For example, a scissors type cutting element may include two shear blades configured to close onto one another and cut the trimmer line 100. In some embodiments, the scissors may have one shearing blade and one opposing surface meant to sever the trimmer line 100 when used in combination with one another.

For example, U.S. Pat. No. 7,908,953 to Yarborough et al., which is incorporated by reference herein, discloses a cutting tool for flexible line, the cutting tool being coupled to a package. For example, the flexible trimmer line may have variability in the amount of angular displacement before the trimmer line is permanently bent or displays permanent deformation or failure. The cutting tool may be configured to sever the trimmer line without bending any point of the trimmer line other than the point of incision. In other embodiments, the trimmer line may be substantially rigid (i.e., incapable of being flexed or bent under a. regular bending force applied by a user) and packaged within a container configured to hold a bundle of the rigid trimmer line.

In some embodiments, as shown in FIG. 6, the trimmer line 100 may be severed by a cutting device 510 configured to create tension in the line, position the line in line with a trough, and sever the line along the plurality of length indicators 102. For example, U.S. Pat. No. 9,555,552 to Skinner et al., which is incorporated by reference herein, discloses such a cutting device. The cutting device includes a body with an open top trough and a blade assembly coupled to the body configured to sever a trimmer line within the open top trough.

In some embodiments, the cutting tool is configured to cut the trimmer line 100 as the line is removed from the package. The cutting tool includes an arm member acting in complementary relationship to a base member to produce a mechanical advantage in a manner that forces the trimmer line 100 received within a. groove to sever the trimmer line 100. For example, U.S. Pat. No. 9,266,698 to Sheehy et al., which is incorporated by reference herein, discloses a suitable package for storing a roll of monofilament line with a cutting tool associated with the package.

### Methods of Manufacturing Trimmer Line

The trimmer line 100 may be manufactured according to any suitable manufacturing processes, such as extrusion. In-line or separately from the line manufacturing process in which the elongated body is produced, the plurality of length indicators may be associated with the elongated body through any suitable means.

In some embodiments, the trimmer line 100 is produced by a extruding an elongated body with an external surface and disposing a plurality of length indicators along the external surface of the elongated body. For example, the plurality of length indicators may be disposed along the external surface by painting, printing, spraying, or otherwise marking, cutting, indenting, or otherwise forming the length indicators onto the external surface during or after the extruding process.

In some embodiments, the trimmer line 100 is manufactured from polymer beads that are melted to form an elongated body. The polymer beads may be formed of varying compounds, colors, and hardness to meet the necessary specifications required by the particular trimmer line to be formed, as described herein. The polymer beads are melted in extruders. Once the polymer beads are melted, the melted polymer is pushed through a die to take the desired shape of trimmer line. As the trimmer line is extruded, the line is soaked in a cool water bath to decrease the temperature in the line. The trimmer line is then stretched until reaching a desired diameter of the trimmer line.

In some embodiments, the process of extruding the trimmer line forms indicators as the trimmer line is formed from a heated mass. For example, as the trimmer line is extruded, a mechanism may cut, indent, or notch a plurality of length indicators along the line or deposit or form a plurality of protrusions, bumps, or ridges. As the trimmer line is cooled, the trimmer line may be wound about a spool and inserted into a package.

While the disclosure has been described with reference to a number of embodiments, it will be understood by those skilled in the art that the disclosure is not limited to such disclosed embodiments. Rather, the disclosed embodiments can be modified to incorporate any number of variations, alterations, substitutions, or equivalent arrangements not described herein, but which are commensurate with the scope of the disclosure.

1. A trimmer line for trimming vegetation, comprising:
an elongated body configured to be cut to a desired measured length by a cutting element, loaded into a rotatable trimmer head and rotated to trim vegetation, the elongated body comprising an external surface; and
a plurality of length indicators disposed along the external surface of the elongated body at regular increments of about one foot to indicate the desired measured length of the trimmer line;
wherein the plurality of length indicators comprise one or more of: dots, lines, circles, and crosses, which are painted or printed on the external surface of the elongated body, such that the external surface of the elongated body comprises a smooth, continuous surface, and
wherein the elongated body comprises a substantially constant cross-sectional shape and/or cross-sectional area along the length of the elongated body and displays a substantially constant failure mode along the length of the elongated body.

2.-9. (canceled)

10. The trimmer line of claim 1, wherein the cross-sectional shape comprises a substantially circular cross-section, a substantially triangular cross-section, or a substantially square cross-section.

11. The trimmer line of claim 1, wherein the plurality of length indicators comprises at least one pair of parallel lines marking a circumference of the elongated body.

12. The trimmer line of claim 1, wherein the plurality of length indicators are green, blue, red, purple, black, yellow, or white.

13. A trimmer line package assembly, comprising the trimmer line of claim 1 and a spool, wherein the elongated body is wrapped about a spool.

14. (canceled)

15. The trimmer line of claim 1, wherein the elongated body is formed of nylon.

16. The trimmer line of claim 1, wherein the plurality of length indicators comprise multiple sets of length indicators configured to designate different incremental lengths along the elongated body.

17. The trimmer line of claim 1, wherein the elongated body has a length of from about 10 feet to about 5,000 feet.

18. The trimmer line of claim 1, wherein the elongated body has a diameter of from about 0.040 inches to about 0.175 inches.

19. The trimmer line of claim 1, wherein the plurality of length indicators each extend about a perimeter of the external surface of the elongated body.

20. A trimmer line package assembly, comprising:
the trimmer line of claim 1, wherein the trimmer line is flexible; and
a package comprising a first side and a second side, wherein the first side is coupled to the second side to form an at least partially enclosed volume, the package further comprising at least one aperture for dispensing the trimmer line from the at least partially enclosed volume,
wherein the trimmer line is disposed within the at least partially enclosed volume in a spooled or wound configuration, and
wherein dispensing the trimmer line from the at least partially enclosed volume comprises unspooling or unwinding the trimmer line.

21. The trimmer line package assembly of claim 20, further comprising the cutting element associated with the package, the cutting element being configured to cut the trimmer line to the desired measured length.

22. The trimmer line package assembly of claim 21, wherein the cutting element comprises a knife, razor blade, or scissors.

23.-33. (canceled)

34. The trimmer line package assembly of claim 20, further comprising wherein the elongated body is wrapped about a spool positioned within the at least partially enclosed volume, wherein the elongated body is wrapped about the spool.

35. The trimmer line package assembly of claim 34, wherein the spool is configured to rotate about an axis as the trimmer line is dispensed from the package.

36.-42. (canceled)

43. The trimmer line package assembly of claim 20, wherein the package is a clamshell type package.

44. The trimmer line package assembly of claim 21, wherein the cutting element comprises an open trough and a blade assembly configured to sever the trimmer line within the open trough.
